(19) United States
(12) Patent Application Publication
(10) Pub. No.: US 2026/0122671 A1
(43) Pub. Date: Apr. 30, 2026

(54) MULTI-ACCESS POINT (AP) COORDINATED TIME DIVISION MULTIPLE ACCESS (TDMA) RESTRICTED TO SPECIFIC TRAFFIC

(71) Applicant: MaxLinear, Inc., Carlsbad, CA (US)

(72) Inventors: Iñaki Val Beitia, Vitoria (ES); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 19/340,760

(22) Filed: Sep. 25, 2025

Related U.S. Application Data
(60) Provisional application No. 63/699,086, filed on Sep. 25, 2024.

(51) Int. Cl. H04W 74/04

(52) U.S. Cl. CPC H04W 74/04

(57) ABSTRACT

An access point (AP) may include a processing device. The processing device may: identify, at the AP, a traffic condition; determine, at the AP, a coordinated time division multiple access (C-TDMA) status based on the traffic condition; and compute, at the AP, a transmission opportunity based on the C-TDMA status. The AP may include a transceiver. The transceiver may transmit, from the AP, a transmission using the transmission opportunity when the C-TDMA status indicates C-TDMA usage.

### RELATED APPLICATION

This application claims the benefit of U.S. Provisional Application No. 63/699,086, filed Sep. 25, 2024, the disclosure of which is incorporated herein by reference in its entirety.

The examples discussed in the present disclosure are related to coordinated time division multiple access (C-TDMA).

### BACKGROUND

Unless otherwise indicated herein, the materials described herein are not prior art to the claims in the present application and are not admitted to be prior art by inclusion in this section.

Applications and use cases with quality of service (QoS)-related usages (e.g., bounded latency and reliability) have been growing in recent times. The QoS services can be characterized by periodic traffic patterns and strict timing for data exchange. Relying on maximizing throughput is not tenable in the long term as a sole focus for correct QoS service operation.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device.

The processing device may: identify, at the AP, a traffic condition; determine, at the AP, a coordinated time division multiple access (C-TDMA) status based on the traffic condition; and compute, at the AP, a transmission opportunity based on the C-TDMA status. The AP may include a transceiver. The transceiver may transmit, from the AP, a transmission using the transmission opportunity when the C-TDMA status indicates C-TDMA usage.

In some examples, an AP may include a processing device. The processing device may receive, at the AP from a sharing AP, a control frame; determine, at the AP, a coordinated time division multiple access (C-TDMA) status based on a traffic condition; and compute, at the AP, a transmission opportunity using the control frame based on the C-TDMA status. The AP may include a transceiver that may transmit the transmission in the transmission opportunity when the C-TDMA status indicates C-TDMA usage.

In some examples, a method may include one or more of: identifying, at an access point (AP), a traffic condition; determining, at the AP, a coordinated time division multiple access (C-TDMA) status based on the traffic condition; computing, at the AP, a transmission opportunity based on the C-TDMA status; and transmitting, from the AP, a transmission using the transmission opportunity when the C-TDMA status indicates C-TDMA usage.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example coordinated time division multiple access (C-TDMA) method.

FIG. 2 illustrates an example coordinated time division multiple access (C-TDMA) method.

FIG. 3 illustrates a block diagram of an example system configured to perform coordinated time division multiple access (C-TDMA).

FIG. 4 illustrates an example process flow of coordinated time division multiple access (C-TDMA).

FIG. 5 illustrates an example process flow of coordinated time division multiple access (C-TDMA).

FIG. 6 illustrates an example process flow of coordinated time division multiple access (C-TDMA).

FIG. 7 illustrates a diagrammatic representation of a machine in the example form of a computing device within which a set of instructions, for causing the machine to perform any one or more of the methods discussed herein, may be executed.

FIG. 8 illustrates an example repeater simulation setup.

FIG. 9 illustrates an example coordinated time division multiple access (C-TDMA) method.

FIG. 10A illustrates an example chart of network latency.

FIG. 10B illustrates an example chart of gaming latency.

FIG. 11A illustrates an example chart of video conference latency.

FIG. 11B illustrates an example chart of video streaming throughput.

FIG. 12A illustrates an example chart of network latency.

FIG. 12B illustrates an example chart of gaming latency.

FIG. 13A illustrates an example chart of video conference latency.

FIG. 13B illustrates an example chart of video streaming latency.

FIG. 14A illustrates an example chart of network latency.

FIG. 14B illustrates an example chart of gaming latency.

FIG. 15A illustrates an example chart of video conference latency.

FIG. 15B illustrates an example chart of video streaming throughput.

FIG. 16 illustrates an example chart of network latency.

FIG. 17A illustrates an example chart of gaming latency.

FIG. 17B illustrates an example chart of video conference latency.

FIG. 18 illustrates an example chart of video streaming latency.

### DESCRIPTION

The 802.11 Wi-Fi® scenarios are getting more congested due to the increase of connected high-performance Wi-Fi® devices competing for the wireless medium. It has been shown that as congestion increases, and under contention-based congestion management, aggregated throughput gets saturated, and the latency is highly affected.

This increase in congestion affects services whose quality of service (QoS) standards are used for correct operation (e.g., reliability, latency, and throughput). Under congested network scenarios, the Access Point (AP) competes against the non-AP stations (STAs) that share the same channel, whether they are part of the same 802.11 Basic Service Set (BSS) or not (e.g., Overlapped BSS (OBSS)). The OBSS can be an independent BSS or part of the same Extended Service Set (ESS).

The approach disclosed herein proposes to use Multi-AP Coordinated TDMA (C-TDMA) for enhancing the latency of the data traffic in both directions, downlink and uplink.

Examples of the present disclosure will be explained with reference to the accompanying drawings.

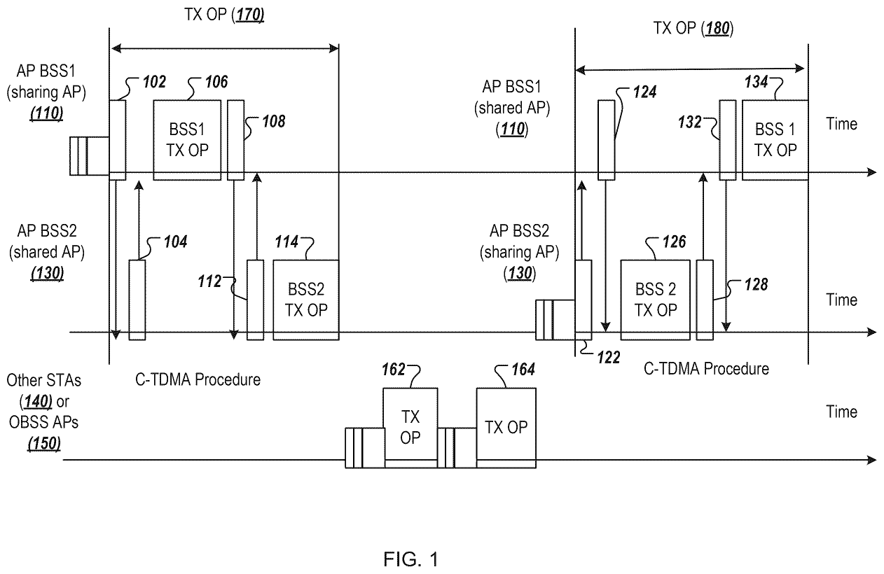

FIG. 1 illustrates the functionality of coordinated TDMA. C-TDMA may include functionality involving an AP BSS1 110, an AP BSS2 130, and other STAs 140 or OBSS APs 150. The AP BSS 1 110, when a sharing AP, may obtain the wireless channel by contention. The AP BSS 1 110 may send a control frame 102 to AP BSS 2 130. AP BSS 2 130 may send a control frame 104 to AP BSS 1 110 in response to receiving the control frame 102 from AP BSS 1 110. The control frames 102, 104 may share information between AP BSS 1 110 and AP BSS 2 130. The information shared may include gained access category (AC), buffer status, timing parameters, or the like. This initial control frame 102, 104 exchange between AP BSS 1 110 and AP BSS 2 130 may protect the transmission opportunity (TX OP) 170.

The AP BSS 1 110 may transmit using BSS 1 TX OP 106 after the exchange of the control frames 102, 104. After transmitting using BSS 1 TX OP 106, AP BSS 1 110 may exchange another control frame 108 with AP BSS 2 130. In response, AP BSS 2 130 may exchange a control frame 112 with AP BSS 1 110. After exchange of control frames 108, 112, AP BSS 2 130 may transmit using BSS 2 TX OP 114. After this transmission, the TX OP 170 is completed. The control frame 108 may include the time allocated between AP BSS 1 110 and AP BSS 2 130. In this example, AP BSS 1 110 may be the sharing AP and AP BSS 2 130 may be the shared AP.

Other STAs 140 or overlapping BSS APs 150 may transmit. For example, after the TX OP 170, a TX OP 162 and/or a TX OP 164 may be transmitted by the STAs 140 or the overlapping BSS APs 150.

AP BSS 1 110 may also be a shared AP and AP BSS 2 130 may be a sharing AP. Control frames 122, 124 may be exchanged between AP BSS 2 130 and AP BSS 1 110. AP BSS 2 130 may transmit using BSS 2 TX OP 126. Control frames 128, 132 may be exchanged between AP BSS 2 130 and AP BSS 1 110. AP BSS 1 110 may transmit using BSS 1 TX OP 134. TX OP 180 may include BSS 2 TX OP 126 and BSS 1 TX OP 134.

Coordinated TDMA may be used when an AP (e.g., a sharing AP) gains the channel for a specific AC, proceeding to share the gained TXOP with a previously selected AP (e.g., shared AP). The procedure may be inefficient because C-TDMA assumes that both APs generate an equivalent number of shared TXOPs in both sides to maintain the fairness and balanced use of the mechanism. Therefore, for the traffic generated in both BSSs, there may be equivalence in terms of traffic periodicity generation and traffic priority (e.g., access category). As a result, the cooperation between the APs is feasible in both sides of the network.

Modifications, additions, or omissions may be made to the components of FIG. 1 without departing from the scope of the present disclosure.

In order to avoid unfairness situations, the execution of C-TDMA may be restricted for a specified access category or traffic identifier (TID), or may be based on traffic specification (TSPEC), or stream classification service (SCS) traffic flow. For instance, two independent BSSs may have high priority traffic using the voice access category, where the corresponding APs may execute the C-TDMA for voice access category, helping each other to transfer their traffic, taking advantage of the shared TXOP. For the rest of the traffic, there may be no coordination between the APs.

The traffic policy agreement may be established during the initial multi-AP negotiation phase, in which a pre-agreement may be formed among potentially participating APs as part of the C-TDMA enrollment process. This pre-agreement may be enforced by higher-layer entities—such as network management applications operated by Internet service providers or enterprise management tools—or autonomously by the intelligence embedded within the APs themselves. This pre-agreement may include the selection of which AC, TID or TSPEC/SCS traffic flow may be used for the C-TDMA execution.

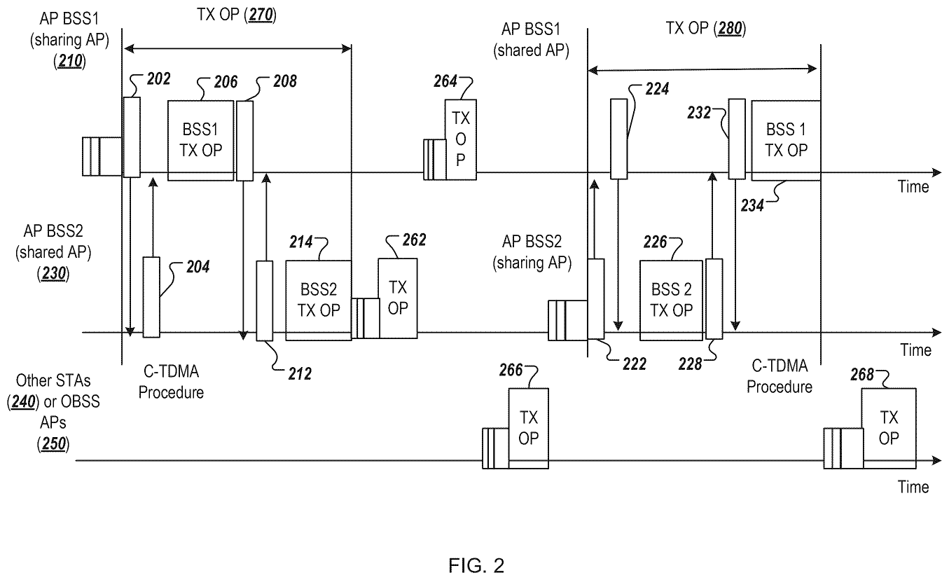

As illustrated in FIG. 2, the C-TDMA procedure may be triggered depending on the traffic conditions agreed upon by the APs or as a result of higher layer signaling. The traffic conditions may be related to: (i) a specific AC, (ii) TID, (iii) TSPEC flow, or (iv) SCS flow.

An exchange of control frames 202, 204 may take place. The AP BSS 1 210, which may be a sharing AP, may transmit during BSS 1 TX OP 206 and the AP BSS 2 230, which may be the shared AP, may transmit during BSS 2 TX OP 214. Another exchange of control frames 208, 212 may take place before the transmission during BSS 2 TX OP 214. The TX OP 270 may include the BSS 1 TX OP 206 and the BSS 2 TX OP 214. After the TX OP 270, the AP BSS 2 230 may transmit during the TX OP 262 and the AP BSS 1 210 may transmit during the TX OP 264. Other STAs 240 or overlapping BSS APs 250 may transmit during the TX OP 266.

The AP BSS 1 210 may be a shared AP and AP BSS 2 230 may be a sharing AP. An exchange of control frames 222, 224 may take place. AP BSS 2 230 may transmit during BSS 2 TX OP 226 and AP BSS 1 210 may transmit during BSS 1 TX OP 234. An exchange of control frames 228, 232 may take place before the BSS 1 TX OP 234 transmission. The TX OP 280 may include BSS 2 TX OP 226 and BSS 1 TX OP 234.

C-TDMA may be triggered for a specific access category. For example, C-TDMA may be triggered for the video access category. In this example, when BSS1 is a sharing AP and BSS2 is a shared AP, BSS1 TX OP 206 may have an access category equal to the video access category (e.g., AC=VI) and BSS2 TX OP 214 may have an access category equal to the video access category (e.g., AC=VI). Similarly, when AP BSS1 is a shared AP and AP BSS2 is a sharing AP, BSS 2 TX OP 226 may have an access category equal to the video access category (e.g., AC=VI) and BSS 1 TX OP 234 may have an access category equal to the video access category (e.g., AC=VI).

Other TX OPs may have different access categories that may not trigger C-TDMA. For example, TX OP 262, TX OP 264, TX OP 266, and TX OP 268 may have an access category that is best efforts (e.g., AC=BE). In this example, the TX OPs may not be shared between different BSSs because the access category is not a voice access category.

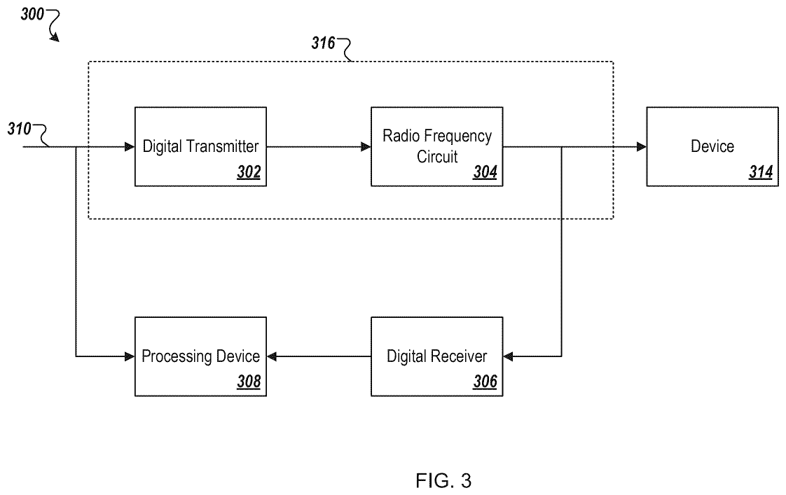

FIG. 3 illustrates a block diagram of an example communication system 300 configured for C-TDMA, in accordance with at least one example described in the present disclosure. The communication system 300 may include a digital transmitter 302, a radio frequency circuit 304, a device 314, a digital receiver 306, and a processing device 308. The digital receiver 306 and the processing device may be configured to receive a baseband signal via connection 310. A transceiver 316 may comprise the digital transmitter 302 and the radio frequency circuit 304.

In some examples, the communication system 300 may include a system of devices that may be configured to communicate with one another via a wired or wireline connection. For example, a wired connection in the communication system 300 may include one or more Ethernet cables, one or more fiber-optic cables, and/or other similar wired communication mediums. Alternatively, or additionally, the communication system 300 may include a system of devices that may be configured to communicate via one or more wireless connections. For example, the communication system 300 may include one or more devices configured to transmit and/or receive radio waves, microwaves, ultrasonic waves, optical waves, electromagnetic induction, and/or similar wireless communications. Alternatively, or additionally, the communication system 300 may include combinations of wireless and/or wired connections. In these and other examples, the communication system 300 may include one or more devices that may be configured to obtain a baseband signal, perform one or more operations to the baseband signal to generate a modified baseband signal, and transmit the modified baseband signal, such as to one or more loads.

In some examples, the communication system 300 may include one or more communication channels that may communicatively couple systems and/or devices included in the communication system 300. For example, the transceiver 316 may be communicatively coupled to the device 314.

In some examples, the transceiver 316 may be configured to obtain a baseband signal. For example, as described herein, the transceiver 316 may be configured to generate a baseband signal and/or receive a baseband signal from another device. In some examples, the transceiver 316 may be configured to transmit the baseband signal. For example, upon obtaining the baseband signal, the transceiver 316 may be configured to transmit the baseband signal to a separate device, such as the device 314. Alternatively, or additionally, the transceiver 316 may be configured to modify, condition, and/or transform the baseband signal in advance of transmitting the baseband signal. For example, the transceiver 316 may include a quadrature up-converter and/or a digital to analog converter (DAC) that may be configured to modify the baseband signal. Alternatively, or additionally, the transceiver 316 may include a direct radio frequency (RF) sampling converter that may be configured to modify the baseband signal.

In some examples, the digital transmitter 302 may be configured to obtain a baseband signal via connection 310. In some examples, the digital transmitter 302 may be configured to up-convert the baseband signal. For example, the digital transmitter 302 may include a quadrature up-converter to apply to the baseband signal. In some examples, the digital transmitter 302 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 302.

In some examples, the transceiver 316 may include one or more subcomponents that may be used in preparing the baseband signal and/or transmitting the baseband signal. For example, the transceiver 316 may include an RF front end (e.g., in a wireless environment) which may include a power amplifier (PA), a digital transmitter (e.g., 302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 304) of the transceiver 316 may be synchronized with the resource controller via the S-plane device, which may contribute to high-accuracy timing with respect to a reference clock.

In some examples, the transceiver 316 may be configured to obtain the baseband signal for transmission. For example, the transceiver 316 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 316 may be configured to generate a baseband signal for transmission. In these and other examples, the transceiver 316 may be configured to transmit the baseband signal to another device, such as the device 314.

In some examples, the device 314 may be configured to receive a transmission from the transceiver 316. For example, the transceiver 316 may be configured to transmit a baseband signal to the device 314.

In some examples, the radio frequency circuit 304 may be configured to transmit the digital signal received from the digital transmitter 302. In some examples, the radio frequency circuit 304 may be configured to transmit the digital signal to the device 314 and/or the digital receiver 306. In some examples, the digital receiver 306 may be configured to receive a digital signal from the RF circuit and/or send a digital signal to the processing device 308.

In some examples, the processing device 308 may be a standalone device or system, as illustrated. Alternatively, or additionally, the processing device 308 may be a component of another device and/or system. For example, in some examples, the processing device 308 may be included in the transceiver 316. In instances in which the processing device 308 is a standalone device or system, the processing device 308 may be configured to communicate with additional devices and/or systems remote from the processing device 308, such as the transceiver 316 and/or the device 314. For example, the processing device 308 may be configured to send and/or receive transmissions from the transceiver 316 and/or the device 314. In some examples, the processing device 308 may be combined with other elements of the communication system 300.

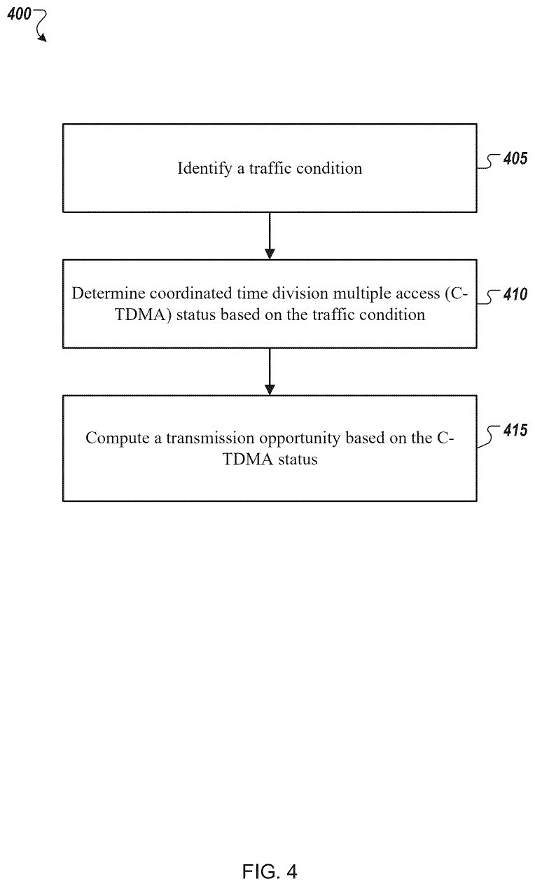

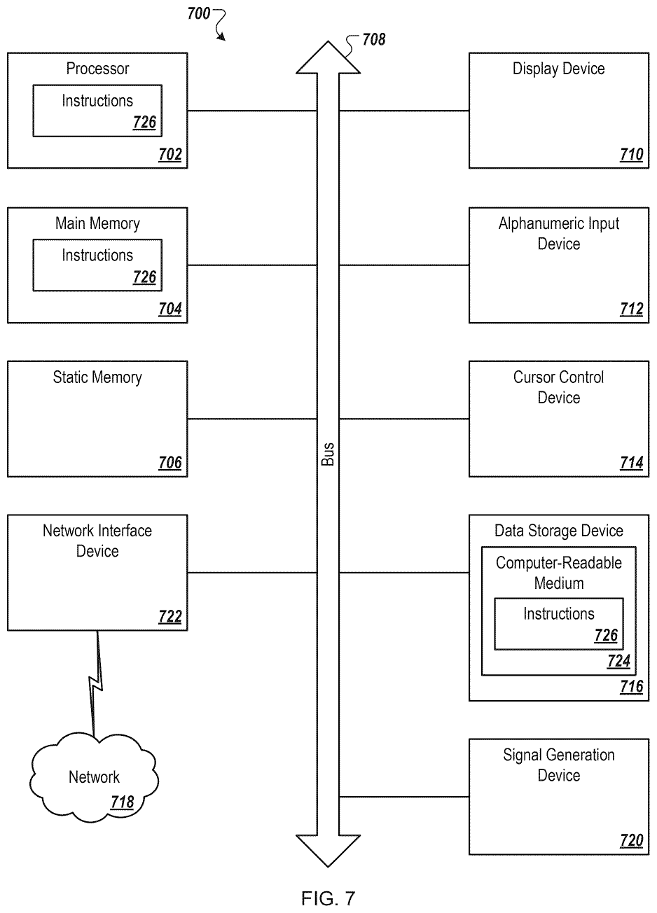

FIG. 4 illustrates a process flow of an example method 400 of C-TDMA, in accordance with at least one example described in the present disclosure. The method 400 may be arranged in accordance with at least one example described in the present disclosure. The method 400 may be performed by processing logic that may include hardware (circuitry, dedicated logic, etc.), software (such as is run on a computer system or a dedicated machine), or a combination of both, which processing logic may be included in the processing device 702 of FIG. 7, the communication system 300 of FIG. 3, or another device, combination of devices, or systems.

The method 400 may begin at block 405 where the processing logic may identify, at the AP, a traffic condition.

At block 410, the processing logic may determine, at the AP, a coordinated time division multiple access (C-TDMA) status based on the traffic condition.

At block 415, the processing logic may compute, at the AP, a transmission opportunity based on the C-TDMA status.

The processing logic may also transmit, from the AP, a transmission using the transmission opportunity when the C-TDMA status indicates C-TDMA usage. The processing logic may also skip, at the AP, transmission using the transmission opportunity when the C-TDMA status indicates C-TDMA non-usage. The processing logic may compute, at the AP for transmission to a shared AP, a control frame comprising one or more of a gained access category, a buffer status, or a timing parameter.

The traffic condition may indicate the C-TDMA usage for the C-TDMA status based on an agreement between the AP and a shared AP. The traffic condition that indicates the C-TDMA usage for the C-TDMA status may be determined based on one or more of an access category (AC), a traffic identifier (TID), a traffic specification (TSPEC), or a stream classification service (SCS). The traffic condition that indicates the C-TDMA usage for the C-TDMA status may be determined based on higher-layer signaling. The transmission opportunity may be shared with a shared AP. The AP may use a first basic service set (BSS) and the shared AP may use a second BSS. The first BSS and the second BSS may be different.

Modifications, additions, or omissions may be made to the method 400 without departing from the scope of the present disclosure. For example, in some examples, the method 400 may include any number of other components that may not be explicitly illustrated or described.

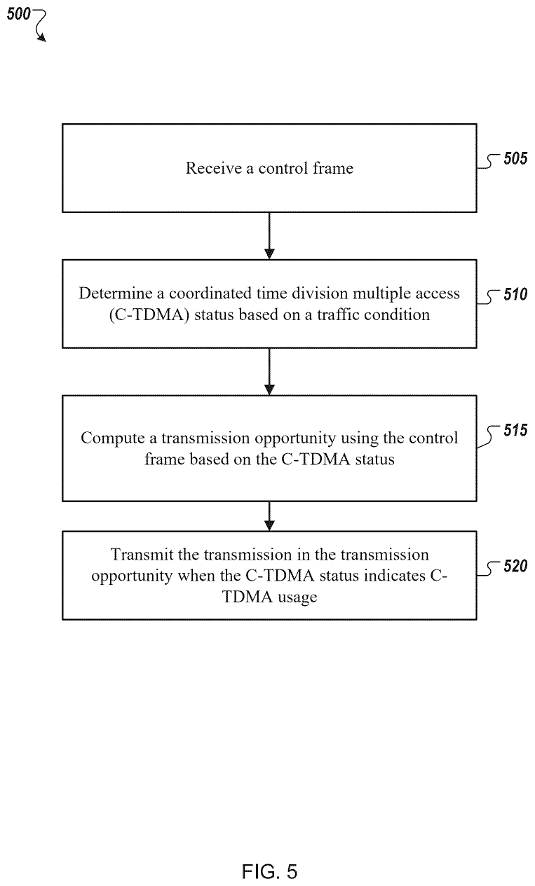

FIG. 5 illustrates a process flow of an example method 500 of C-TDMA, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 300 of FIG. 3, or another device, combination of devices, or systems.

The method 500 may begin at block 505 where the processing logic may receive, at the AP from a sharing AP, a control frame.

At block 510, the processing logic may determine, at the AP, a coordinated time division multiple access (C-TDMA) status based on a traffic condition.

At block 515, the processing logic may compute, at the AP, a transmission opportunity using the control frame based on the C-TDMA status.

At block 520, the processing logic may transmit the transmission in the transmission opportunity when the C-TDMA status indicates C-TDMA usage.

The processing logic may skip, at the AP, transmission in the transmission opportunity when the C-TDMA status indicates C-TDMA non-usage.

Modifications, additions, or omissions may be made to the method 500 without departing from the scope of the present disclosure. For example, in some examples, the method 500 may include any number of other components that may not be explicitly illustrated or described.

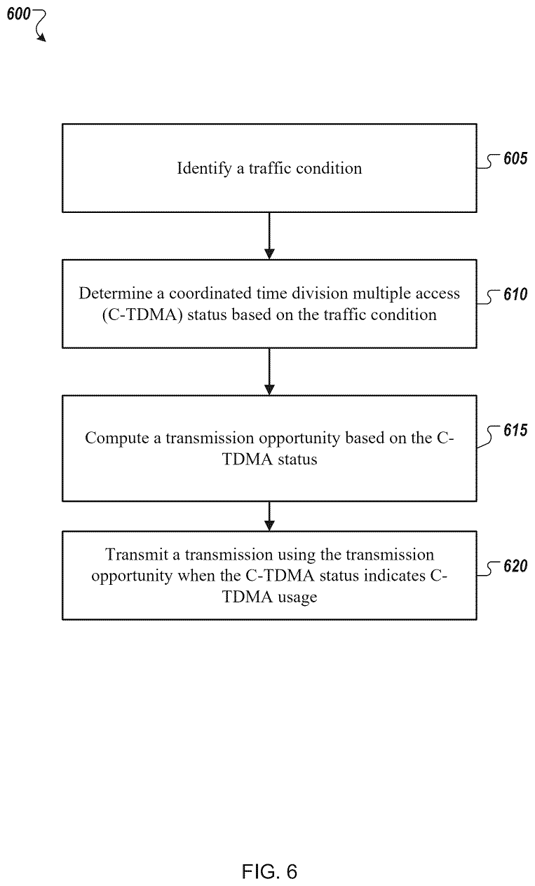

FIG. 6 illustrates a process flow of an example method 600 of C-TDMA, in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device 702 of FIG. 7, the communication system 300 of FIG. 3, or another device, combination of devices, or systems.

The method 600 may begin at block 605 where the processing logic may identify, at an access point (AP), a traffic condition.

At block 610, the processing logic may determine, at the AP, a coordinated time division multiple access (C-TDMA) status based on the traffic condition.

At block 615, the processing logic may compute, at the AP, a transmission opportunity based on the C-TDMA status.

At block 620, the processing logic may transmit, from the AP, a transmission using the transmission opportunity when the C-TDMA status indicates C-TDMA usage.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1

### Simulation Setup

A simulation was setup to provide: (1) performance evaluation of C-TDMA under congested scenarios, including OBSS/ESS and repeater deployments, focusing on time-sensitive services, (2) realistic simulation frameworks including modeling of high-level transport protocols, and (3) different C-TDMA strategies to calculate the shared TXOP length.

IEEE 802.11bn targets the improvement of packet delivery by reducing the transmission latency and enhancing network reliability. Applications and use cases with QoS-related standards (e.g., bounded latency and reliability) have been growing in recent times. Scenarios were examined where the traffic load for different BSSs was not balanced, creating new network conditions and analyzing the performance under different strategies for deciding which fraction of the gaining TXOP was shared. Therefore, aspects to be taken into account for making decisions about how and with whom to cooperate were identified.

Coordinated TDMA may allow cooperation of two APs, by sharing the gained TXOP between them. Both BSSs may take advantage of the gained time, reducing the waiting time to access the channel, and hence the latency of the different traffic flows, e.g., for those that have higher priority access category. C-TDMA may not change the time used per BSS; rather, C-TDMA may redistribute the assigned time to the coordinated APs, getting an improvement in latency, by reducing the access time for the shared AP.

For the simulation setup, two scenarios were identified where the C-TDMA mechanism may be deployed: (1) OBSS scenario: coordination between one pair of independent neighboring BSSs sharing the same channel, and (2) repeater (ESS) scenario: coordination between two in-home AP devices from the same network (ESS), and sharing the same channel.

### OBSS Scenario Setup:

Three OBSS scenarios were provided under two different conditions. In scenario 1, balanced OBSS was used in which four BSSs shared the same channel, having balanced traffic load and number of associated STAs between the BSSs. Coordination was enabled between BSS1 and BSS2, while BSS3/4 remained as uncoordinated OBSS.

In scenario 2, unbalanced OBSSs were used in which two BSSs shared the same channel, having unbalanced traffic load and number of associated STAs between the two BSSs. There was similar network traffic generation and priority classification in both BSSs: Both APs generated TXOPs on commonly assigned ACs, creating opportunities on both sides, having an effective cooperation.

In scenario 3, unbalanced OBSS were used with unequal priority assignment in which three BSSs shared the same channel. Coordination was possible between BSS1 and BSS2, while BSS3 remained as an OBSS. There was an unbalanced traffic load and number of associated STAs between BSS1 and BSS2. There was different network traffic generation and priority assignment in the BSSs. That is, both APs did not generate TXOPs on commonly assigned ACs, creating fewer cooperation opportunities.

For the three OBSS scenarios, the data frames PHY/MAC link configuration for associated STAs was single user (SU) 80 megahertz (MHz)/1SS/MCS:11 for creating overloading situation. In addition, OBSS STAs were in [physical detect (PD), energy detect (ED)] range and BSS STAs were in ED range.

### Repeater Scenario Setup:

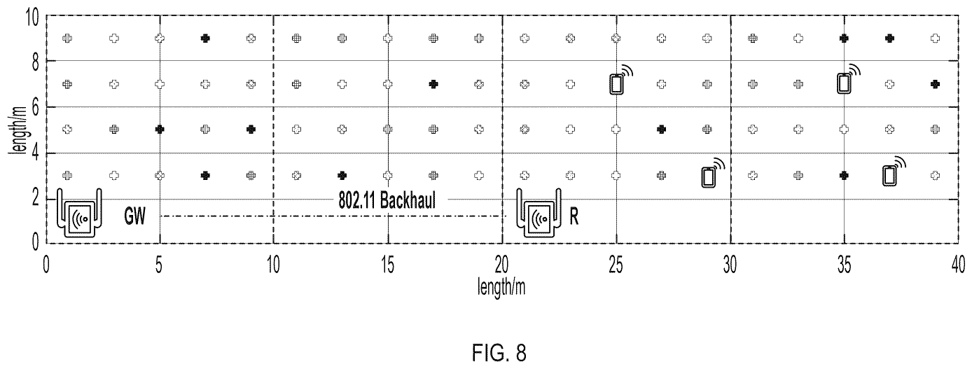

As illustrated in FIG. 8, ESS included gateway (GW) and repeater (R) devices, connected through a wireless backhaul. The repeater included a non-AP STA and AP devices, internally bridged and using the same radio. The repeater had 5 associated STAs, creating an unbalanced situation between GW and R. For the setup, OBSS STAs were in [PD, ED] range, and BSS STAs were in ED range. The gateway and repeater were in ED range. There were two possible coordination scenarios: (1) uncoordinated and (2) GW/R coordinated (both do C-TDMA). The PHY/MAC configuration for data frames was SU 80 MHz/1SS/MCS:11 for creating the overloading situation.

### Example 2

### Traffic Generation (OBSS Case)—Scenario 1

Of four BSSs, two BSSs may be coordinated (e.g., using C-TDMA). The BSSs had different data services. STA1 service was video conferencing (downlink (DL)/uplink (UL) 3 Mbps, 250B length) [user datagram protocol (UDP), VI_AC]. STA2 service was video streaming (4K ultra high definition (UHD) H264 (DL 32 Mbps, 1500B length) [closed-loop transmission control protocol (TCP), VI_AC]). STA3 service was gaming (DL/UL 140 kbps, Periodicity 7 ms, 110B length) [UDP, VO_AC]. STA4 service was cloud file sync (DL/UL 10 Mbps, 1500B length) [closed-loop TCP, BE_AC]. STA5 service was a camera (UL 2 Mbps, 1450B length) [UDP, VI_AC].

### Example 3

### Traffic Generation (OBSS Case)—Scenario 2

Two BSSs may be coordinated (C-TDMA). There was unbalanced traffic and associated STAs, with respect to the BSSs.

For BSS1, the data services included 9 associated STAs: 2x video conference (DL/UL 3 Mbps, 250B length) [UDP, VI_AC]; 2x video streaming 4K UHD H264 (DL 64 Mbps, 1500B length) [closed-loop TCP, VI_AC]; 2x gaming (DL/UL 140 kbps, Periodicity 7 ms, 110B length) [UDP, VO_AC]; 2x cloud file sync (DL/UL 10 Mbps, 1500B length) [closed-loop TCP, BE_AC]; and 1x camera (UL 2 Mbps, 1450B length) [UDP, VI_AC].

For BSS2, the data services included 5 associated STAs: 1x video conference (DL/UL 3 Mbps, 250B length) [UDP, VI_AC]; 1x video streaming 4K UHD H264 (DL 64 Mbps, 1500B length) [closed-loop TCP, VI_AC]; 1x gaming (DL/UL 140 kbps, periodicity 7 ms, 110B length) [UDP, VO_AC]; 1x cloud file sync (DL/UL 10 Mbps, 1500B length) [closed-loop TCP, BE_AC]; and 1x camera (UL 2 Mbps, 1450B length) [UDP, VI_AC].

### Example 4

### Traffic Generation (OBSS Case) —Scenario 3

BSS1 and BSS2 may be coordinated (C-TDMA), and there may be a third OBSS (BSS3).

For BSS1, the data services included 7 associated STAs: 2x video conference (DL/UL 3 Mbps, 250B length) [UDP, VI_AC]; 2x video streaming 4K UHD H264 (DL 64 Mbps, 1500B length) [closed-loop TCP, VI_AC]; 1x gaming (DL/UL 140 kbps, periodicity 7 ms, 110B length) [UDP, VO_AC]; 1x cloud file sync (DL/UL 10 Mbps, 1500B length) [closed-loop TCP, BE_AC]; and 1x camera (UL 2 Mbps, 1450B length) [UDP, VI_AC].

For BSS2, the data services included 3 associated STAs: 1x gaming (DL/UL 140 kbps, periodicity 7 ms, 110B length) [UDP, VO_AC]; 1x cloud file sync (DL/UL 10 Mbps, 1500B length) [closed-loop TCP, BE_AC]; and 1x camera (UL 2 Mbps, 1450B length) [UDP, VI_AC].

For BSS3, the data services included 5 associated STAs: 1x video conference (DL/UL 3 Mbps, 250B length) [UDP, VI_AC]; 1x video streaming 4K UHD H264 (DL 64 Mbps, 1500B length) [closed-loop TCP, VI_AC]; 1x gaming (DL/UL 140 kbps, periodicity 7 ms, 110B length) [UDP, VO_AC]; 1x cloud file sync (DL/UL 10 Mbps, 1500B length) [closed-loop TCP, BE_AC]; 1x camera (UL 2 Mbps, 1450B length) [UDP, VI_AC].

### Example 5

### Traffic Generation (repeater Case)

The gateway associated STAs included a STA repeater having a backhaul link including all the traffic transferred to the repeater.

The repeater associated STAs included: STA1 service: video conference (DL/UL 3 Mbps, 250B length) [UDP, VI_AC]; STA2 service: video streaming 4K UHD H264 (DL 64 Mbps) [closed-loop TCP, VI_AC]; STA3 service: video streaming 4K UHD H264 (DL 64 Mbps) [closed-loop TCP, VI_AC]; STA4 service: gaming (DL/UL 140 kbps, periodicity 7 ms, 110B length) [UDP, VO_AC]; STA5 service: camera (UL 2 Mbps, 1450B length) [UDP, VI_AC]. The backhaul link provided STA1-5 services. All the STAs generated UL traffic (using trigger based (TB) and enhanced distributed channel access (EDCA) mechanisms).

### Example 6

### C-TDMA Strategies

Four different approaches were used to decide the shared TXOP length.

In strategy 1 (S1), the sharing AP shared the remaining TXOP length, after the sharing AP local buffers were empty (for the gained and higher ACs). The TXOP ended after the shared AP finished, which may send a CF-end frame for early termination.

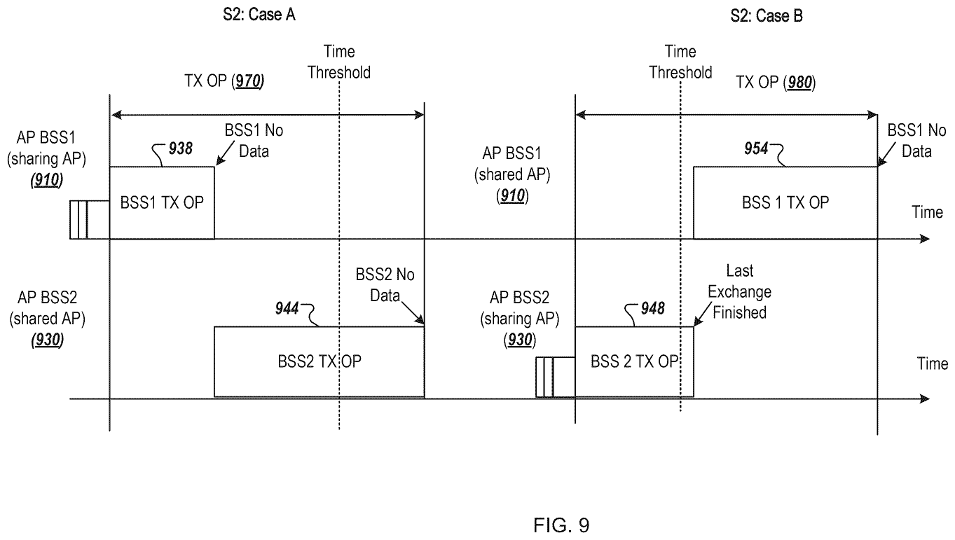

As illustrated in FIG. 9, in strategy 2 (S2), Case A, AP BSS1 910 may transmit in BSS1 TX OP 938. When AP BSS1 910 has no data, AP BSS2 930 may transmit in BSS2 TX OP 944. When AP BSS2 930 has no data, the transmission may stop. TX OP 970 may include BSS 1 TX OP 938 and BSS 2 TX OP 944. In S2, Case B, AP BSS2 930 may transmit in BSS2 TX OP 948. When AP BSS2 930 has a last exchange, AP BSS1 910 may transmit in BSS 1 TX OP 954. When AP BSS1 910 has no data, the transmission may stop. TX OP 980 may include BSS 2 TX OP 948 and BSS 1 TX OP 954.

In S2, a time threshold was set from higher layers (managed networks). The sharing AP may start sharing the TXOP before the time threshold if the sharing AP has no more data, for the gained and higher ACs, in its BSS (Case A). The sharing AP may delay sharing the TXOP if there is an ongoing data exchange that exceeds the time threshold (Case B). Therefore, there may be defined a flexible maximum time length that the sharing AP can use for transferring data, established by an external arbiter, while the rest may be used by the shared AP. The TXOP may end after the shared AP finishes, which may send a CF-end frame for early termination.

In strategy 3 (S3), a time threshold may be dynamically calculated based on the buffer status knowledge. Based on the current knowledge of the buffer's status for the gained AC, APs may calculate the TXOP length. The sharing AP may sends its calculation in the initial control frame (ICF), and the shared AP may include its calculation in the initial control response (ICR). The sharing AP may prioritize its own needs when the sum of both calculations exceeds the TXOP limit. Once the pre-negotiation concludes, S2 rules may be followed.

In strategy 4 (S4), the time threshold may be dynamically calculated based on the buffer status knowledge and traffic prediction. In addition to the estimation from strategy 3, the APs may estimate additional time based on the prediction of future incoming data frames along the TXOP to provide a more accurate calculation. Based on the previous calculation, S3 rules may be followed.

In summary, S1 may work in standalone mode, while S2-S4 may use pre-negotiation or management from higher layers. Each strategy may be selected depending on the nature of the network.

### Example 7

### OBSS Scenario 1—Balanced OBSS

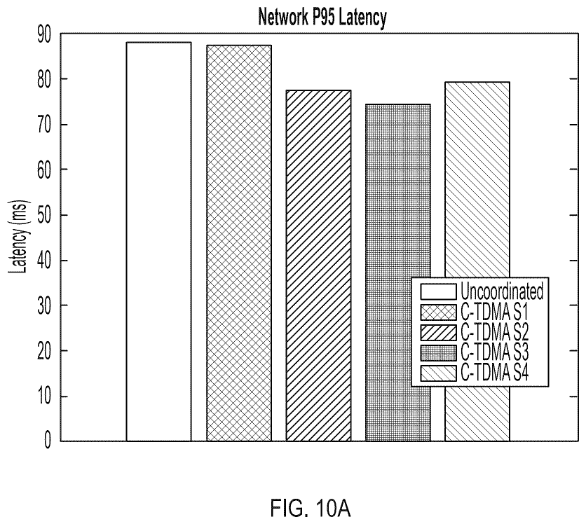

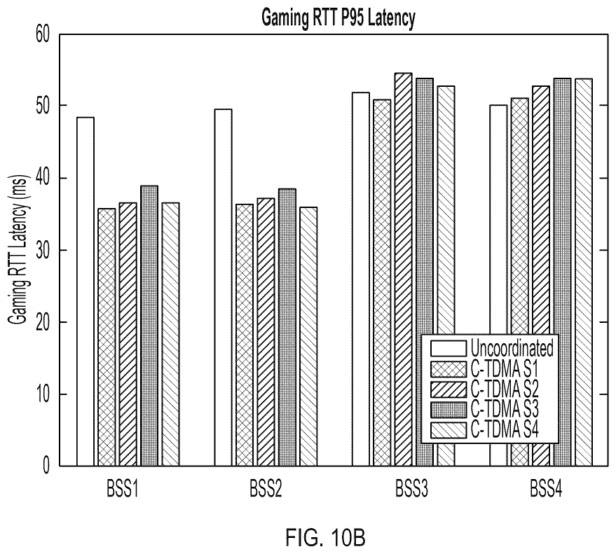

As illustrated in FIG. 10A, the latency for OBSS scenario 1 (i.e., balanced OBSS) varied for the different strategies. The network tail latency showed a slight reduction for the strategies (except for S1), as BSS3 and BSS4 remain uncoordinated.

As illustrated in FIG. 10B, gaming service showed similar performance for the 4 C-TDMA strategies because gaming service sent short-duration data frames with minimal problems for sharing time from a gained TXOP.

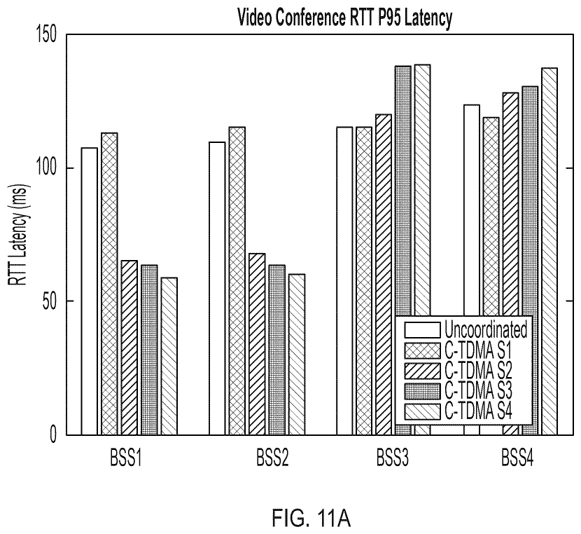

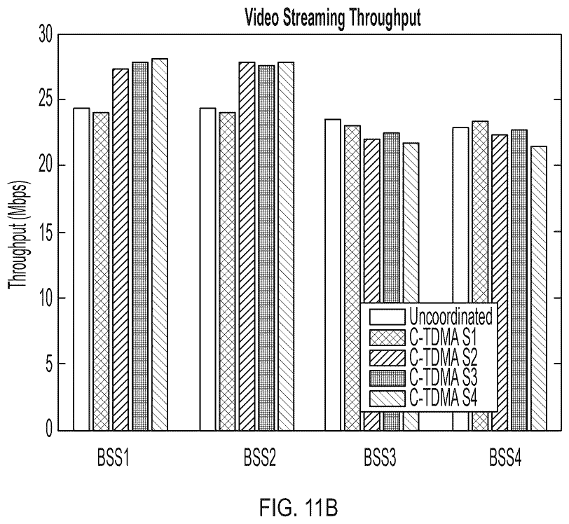

As illustrated in FIGS. 11A-11B, video conferencing and video streaming showed similar behavior, except for S1. Similar performance was reported by the other strategies, because both networks were balanced and shared similar traffic. For this setup, managed threshold and dynamic threshold calculation converged to similar results, being similar strategies under this balanced situation.

### Example 8

### OBSS Scenario 2—Unbalanced OBSS

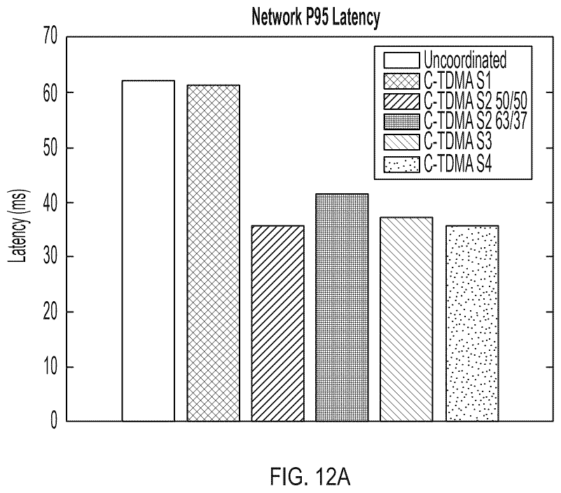

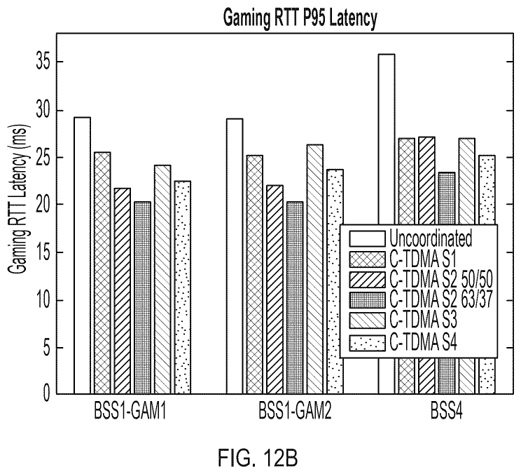

As illustrated in FIGS. 12A-12B, overall reduction of the network tail latency occurred for the strategies, except for S1, which had a minor impact on the performance. Gaming service showed similar performance for the C-TDMA strategies because gaming service sends short-duration data frames having no problems sharing time from a gained TXOP.

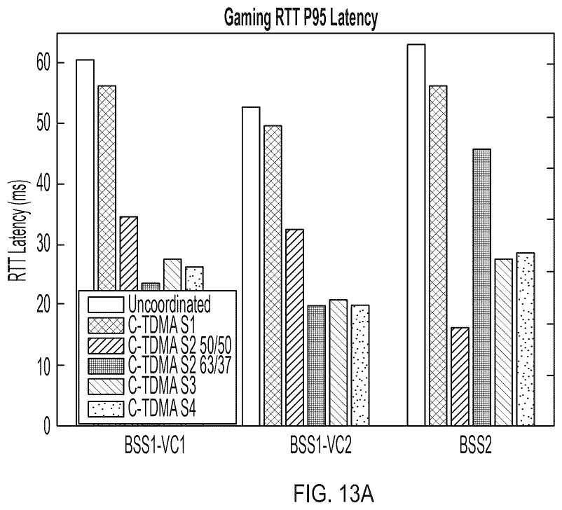

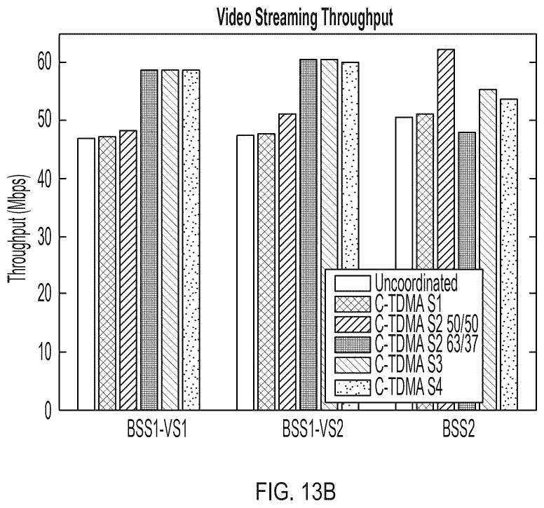

As illustrated in FIGS. 13A-13B, video conferencing and video streaming showed similar behavior, but depending on the strategy there was a different impact. Both S2 strategies had the opposite result. In the case of balanced S2, more resources were provided to BSS2, while for unbalanced S2 fewer resources were provided to BSS2. Strategy S3/S4 adapted dynamically, giving an intermediate improvement, balancing the performance gain.

### Example 9

### OBSS Scenario 3—Unequal Priority

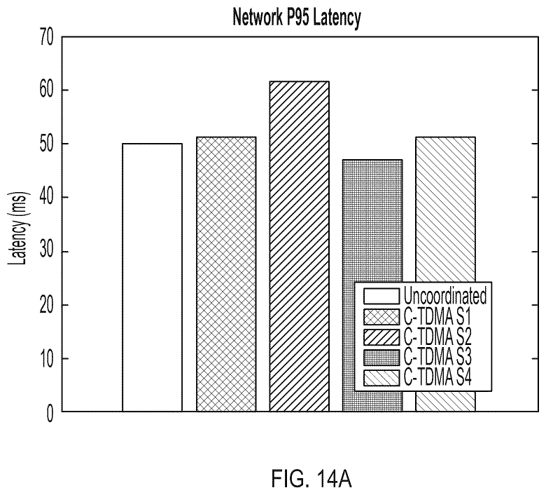

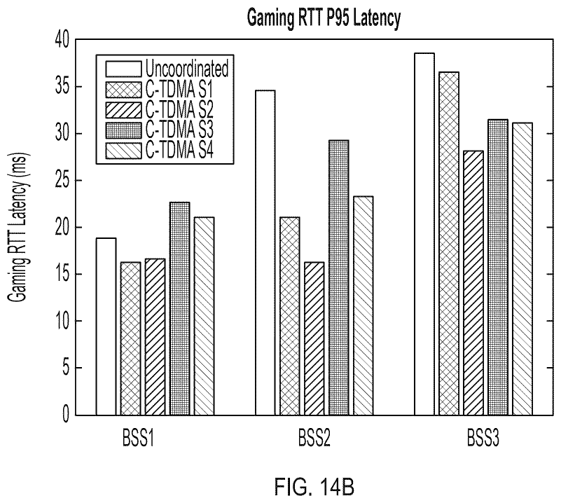

As illustrated in FIG. 14A, the overall network latency performance was decreased as a consequence of having large unbalanced traffic between BSS1 and BSS2. At the same time both networks did not share the same priority AC for the main services, which did not allow effective cooperation.

As illustrated in FIG. 14B, for gaming, both networks generated VO AC traffic and took advantage from lower priority opportunities. As BSS2 generated fewer VI opportunities to share, there was no advantage for BSS1. On the other side, BSS2 took advantage of the BSS1 network.

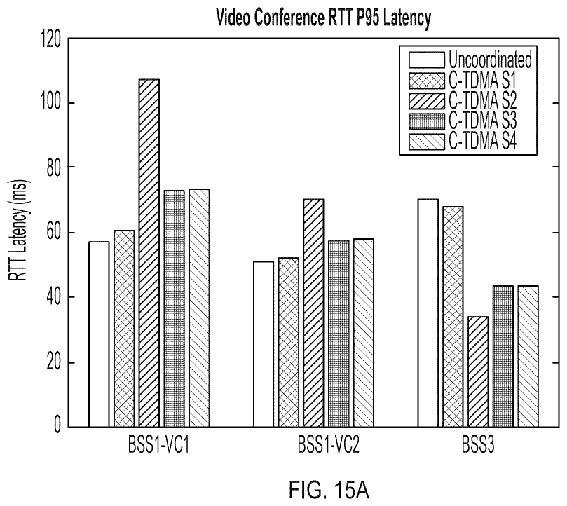

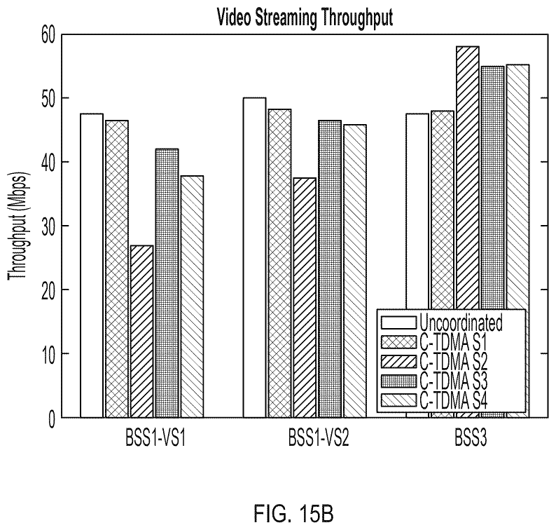

As illustrated in FIGS. 15A-15B, for video streaming and video conferencing, BSS2 had no VI AC traffic; therefore, there was minimal effective cooperation between the APs, resulting in performance degradation. In the case of having cooperation between BSS1 and BSS3, instead of BSS2, the results would be different, similar to the ones found in OBSS scenario 1.

### Example 10

### Summary (OBSS)

For OBSS scenarios, the C-TDMA coordination was effective in the case that both APs generated an equal number of channel gain opportunities in the same or equivalent ACs (priority); otherwise, the performance of both networks deteriorated. For balanced OBSS, similar performance results were obtained for managed and dynamic C-TDMA threshold setup, while dynamic calculation seemed to be more adequate in OBSS scenarios, considering its uncorrelated nature.

### Example 11

### Repeater/Mesh Simulation Results

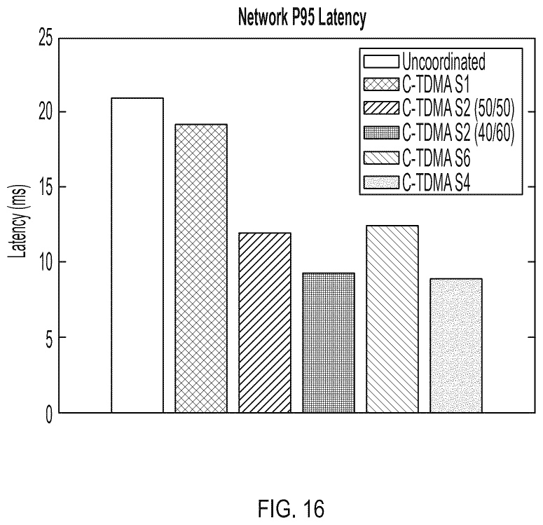

As illustrated in FIG. 16, five different coordination setups were used including: (a) no coordination between GW and repeater (baseline), (b) C-TDMA strategy 1 (S1), (c) C-TDMA strategy 2 (S2) (having a sharing threshold of 50/50 in which 50% of TXOP length may be used for the GW, and 50% length may be used for the repeater; and having a sharing threshold of 40/60 in which 40% of TXOP length may be used for the GW and 60% length may be used for the repeater); (d) C-TDMA strategy 3 (S3), and (e) C-TDMA strategy 4 (S4).

C-TDMA based on S2/S3/S4 improved the network latency tail by 69% to 136%, whereas S1 had a minor impact on the performance. C-TDMA S4 based on dynamic TXOP calculation provided the best performance, obtaining a similar result for the unbalanced tuning of S2 (40/60).

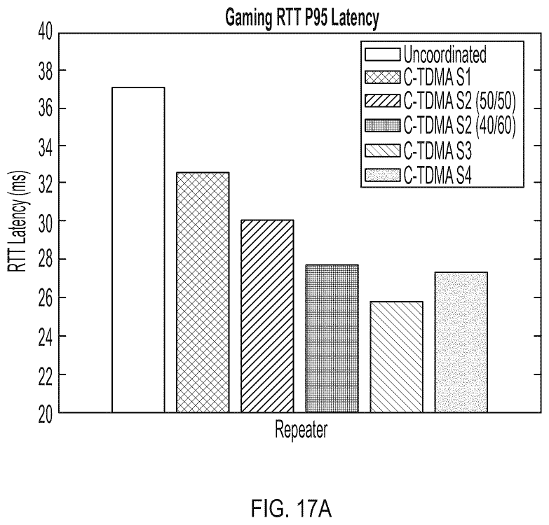

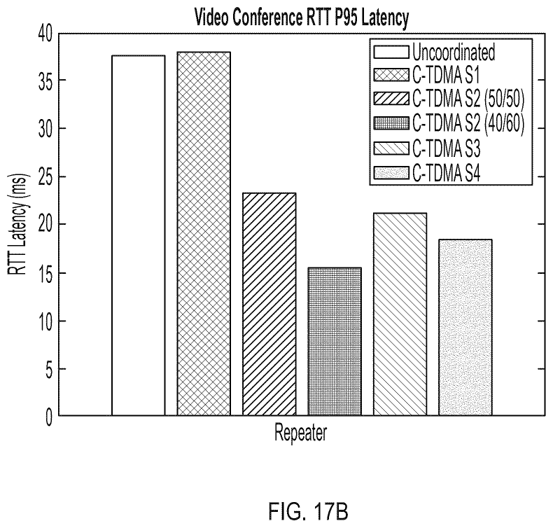

As illustrated in FIG. 17A-17B, C-TDMA based on unbalanced S2 and S3/S4 improved the gaming and video conference latency tail, whereas S1 had a low impact on the performance improvement, and balanced S2 was less effective due to the network topology characteristics.

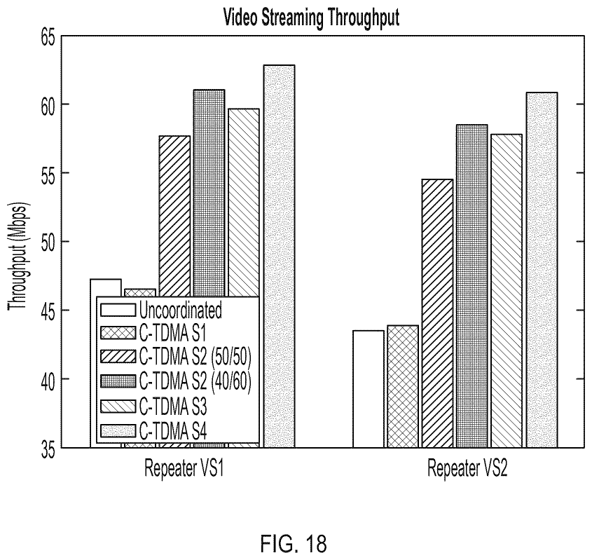

As illustrated in FIG. 18, regardless of video streaming throughput, the best performance was obtained for unbalanced S2 and S4. The performance difference between balanced S2 and S4 was due to the nature of the unbalanced network topology, whereas S4 adjusted dynamically. Even in the unbalanced network situation, C-TDMA S2 still performed well because both BSSs were correlated.

### Example 12

### Summary (Repeater/Mesh)

C-TDMA improved the high-priority latency performance in repeater/mesh topologies. In repeater/mesh scenarios, the correlated backhaul traffic flow helped to provide cooperation between the APs, unlike in the OBSS scenario. Both C-TDMA strategies, based on managed setup or dynamic calculation provided similar performance for the case where the C-TDMA threshold was set from higher layers (managed) and the case where the threshold was dynamically calculated and negotiated between the APs.

### Example 13

### Conclusion

Performance results for C-TDMA under different topologies, traffic situations, and sharing TXOP calculation strategies were provided. The network topology and traffic setup defined the suitability of cooperation between the APs in which a wrong choice may deteriorate the performance of the networks. The C-TDMA coordination was effective in the case that both APs generated an equal number of channel gain opportunities in equivalent ACs. Consequently, the C-TDMA mechanism may be enabled per AC, instead of being used for the network traffic, e.g., for those high-priority services being used in both networks.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP) comprising:
a processing device operable to:
identify, at the AP, a traffic condition;
determine, at the AP, a coordinated time division multiple access (C-TDMA) status based on the traffic condition; and
compute, at the AP, a transmission opportunity based on the C-TDMA status; and
a transceiver operable to:
transmit, from the AP, a transmission using the transmission opportunity when the C-TDMA status indicates C-TDMA usage.

2. The AP of claim 1, wherein the transceiver is further operable to skip, at the AP, transmission using the transmission opportunity when the C-TDMA status indicates C-TDMA non-usage.

3. The AP of claim 1, wherein the traffic condition that indicates the C-TDMA usage for the C-TDMA status is determined based on an agreement between the AP and a shared AP.

4. The AP of claim 1, wherein the traffic condition that indicates the C-TDMA usage for the C-TDMA status is determined based on one or more of an access category (AC), a traffic identifier (TID), a traffic specification (TSPEC), or a stream classification service (SCS).

5. The AP of claim 1, wherein the traffic condition that indicates the C-TDMA usage for the C-TDMA status is determined based on higher-layer signaling.

6. The AP of claim 1, wherein the processing device is further operable to:
compute, at the AP for transmission to a shared AP, a control frame comprising one or more of a gained access category, a buffer status, or a timing parameter.

7. The AP of claim 1, wherein the transmission opportunity is shared with a shared AP.

8. The AP of claim 7, wherein the AP uses a first basic service set (BSS) and the shared AP uses a second BSS, wherein the first BSS and the second BSS are different.

9. An access point (AP) comprising:
a processing device operable to:
receive, at the AP from a sharing AP, a control frame;
determine, at the AP, a coordinated time division multiple access (C-TDMA) status based on a traffic condition; and
compute, at the AP, a transmission opportunity using the control frame based on the C-TDMA status; and
a transceiver operable to transmit the transmission in the transmission opportunity when the C-TDMA status indicates C-TDMA usage.

10. The AP of claim 9, wherein the transceiver is further operable to skip, at the AP, transmission in the transmission opportunity when the C-TDMA status indicates C-TDMA non-usage.

11. The AP of claim 9, wherein the traffic condition that indicates the C-TDMA usage for the C-TDMA status is determined based on an agreement between the AP and the sharing AP.

12. The AP of claim 9, wherein the traffic condition that indicates the C-TDMA usage for the C-TDMA status is determined based on one or more of an access category (AC), a traffic identifier (TID), a traffic specification (TSPEC), or a stream classification service (SCS).

13. The AP of claim 9, wherein the traffic condition that indicates the C-TDMA usage for the C-TDMA status is determined based on higher-layer signaling.

14. The AP of claim 9, wherein the AP uses a first basic service set (BSS) and the sharing AP uses a second BSS, wherein the first BSS and the second BSS are different.

15. A method, comprising:
identifying, at an access point (AP), a traffic condition;
determining, at the AP, a coordinated time division multiple access (C-TDMA) status based on the traffic condition;
computing, at the AP, a transmission opportunity based on the C-TDMA status; and
transmitting, from the AP, a transmission using the transmission opportunity when the C-TDMA status indicates C-TDMA usage.

16. The method of claim 15, further comprising:
skipping, at the AP, transmission using the transmission opportunity when the C-TDMA status indicates C-TDMA non-usage.

17. The method of claim 15, wherein the traffic condition that indicates the C-TDMA usage for the C-TDMA status is determined based on an agreement between the AP and a shared AP.

18. The method of claim 15, wherein the traffic condition that indicates the C-TDMA usage for the C-TDMA status is determined based on one or more of an access category (AC), a traffic identifier (TID), a traffic specification (TSPEC), or a stream classification service (SCS).

19. The method of claim 15, wherein the traffic condition that indicates the C-TDMA usage for the C-TDMA status is determined based on higher-layer signaling.

20. The method of claim 15, further comprising:
computing, at the AP for transmission to a shared AP, a control frame comprising one or more of a gained access category, a buffer status, or a timing parameter.
